(19) United States
(12) Patent Application Publication
(10) Pub. No.: US 2025/0186822 A1
(43) Pub. Date: Jun. 12, 2025

(54) FIRE-EXTINGUISHER MONITORING SYSTEM

(71) Applicant: WINGALA IOT PTY LTD, Wollongong, New South Wales (AU)

(72) Inventor: Michael Formica, Belrose, New South Wales (AU)

(21) Appl. No.: 18/685,844

(22) PCT Filed: Aug. 25, 2022
(86) PCT No.: PCT/AU2022/051020

§ 371 Date: Feb. 22, 2024

(30) Foreign Application Priority Data
Aug. 25, 2021 (AU) 2021221576

(51) Int. Cl. A62C 37/50; A62C 13/78; G01G 17/04

(52) U.S. Cl. CPC A62C 37/50; A62C 13/78; G01G 17/04

(57) ABSTRACT

A fire-extinguisher monitoring system includes a monitoring device that is externally locatable relative to a fire extinguisher, the monitoring device being arranged or configured to non-intrusively monitor a status of the fire extinguisher, the status including at least one of a presence of the fire extinguisher and a level of fire-suppression fluid contained by the fire extinguisher.

### FIELD

The present invention relates to a system for monitoring a fire extinguisher.

### BACKGROUND

The Building Code of Australia (BCA) standard requires portable fire extinguishers to be positioned at a number of locations in a building for safety reasons. The fire extinguishers need to be checked regularly to ensure compliance with the BCA standard. In particular, the fire extinguishers are checked to ensure that they are working and haven't been discharged, vandalised, or stolen. The task of checking and maintaining the fire extinguishers can be time-consuming especially in larger buildings (e.g. a campus), which would require more fire extinguishers.

### SUMMARY OF INVENTION

Preferred embodiments of the present invention seek to address one or more of the problems described above and/or to at least provide the public with a useful choice.

An aspect of the present invention provides a fire-extinguisher monitoring system including: a monitoring device that is externally locatable relative to a fire extinguisher, the monitoring device being arranged or configured to non-intrusively monitor a status of the fire extinguisher, the status including at least one of a presence of the fire extinguisher and a level of fire-suppression fluid contained by the fire extinguisher.

The monitoring device may include a load cell or a strain gauge for presence detection and/or weight detection of the fire extinguisher. Preferably, from the weight of the fire extinguisher, a level of fire-suppression fluid contained by the fire extinguisher can be determined. The monitoring device may additionally or alternatively include a reed switch for sensing a magnet portion of the fire extinguisher for presence detection of the fire extinguisher, or an ultrasonic sensor for level detection of fire-suppression fluid contained by the fire extinguisher of the fire extinguisher, or an electronic reader system for reading a tag or barcode of the fire extinguisher for presence detection of the fire extinguisher.

The fire-extinguisher monitoring system preferably further includes an output device that is configured to provide an audio output and/or a visual output upon a change of monitored status of the fire-extinguisher. The output device may, for example, be configured to provide an output upon the fire extinguisher being removed and/or upon detecting a reduced or low fire-extinguishing content in the fire extinguisher.

The fire-extinguisher monitoring system preferably further includes a communications module configured to receive information relating to the status of the fire extinguisher from the monitoring device and transmit the information relating to the status to a server and/or electronic device. The communications module may be configured to communicate with the server and/or electronic device over a short-range communications protocol or over a long-range communications protocol. Alternatively, the communications module may be configured for wired communication.

The fire-extinguisher monitoring system preferably further includes a processor for receiving and/or transmitting information from the monitoring device at fixed intervals or irregular intervals. By way of example, the processor receives and/or transmits information from the sensor once a day, once a week, once a month. Additionally or alternatively, the processor is configured to transmit the information received from the monitoring device upon determining a change in state of the fire extinguisher.

The fire-extinguisher monitoring system may include a local computer memory that stores a digital address or unique identifier, wherein the digital address or unique identifier is indicative of a location of the monitoring device. Alternatively, the fire-extinguisher monitoring system may further include a GPS tracker for location determination.

Another aspect of the present invention provides a mount to which a fire extinguisher can be mounted, the mount including the fire-extinguisher monitoring system of the aspect previously described above.

The mount preferably includes an arm portion on which the fire extinguisher can be hung, the arm portion including the monitoring device. In some examples, the mount includes a foot portion on which the fire extinguisher can be located, the foot portion including the monitoring device. The mount may also include a body portion that is attachable to a building wall, the fire extinguisher being next to the body portion, the body portion including the monitoring device.

### BRIEF DESCRIPTION OF DRAWINGS

Preferred embodiments of the present invention will now be described, by way of non-limiting example

FIG. 1 shows a schematic diagram of a monitoring network according to an embodiment of the present invention;

FIG. 2 shows a schematic view of a monitoring device according to an embodiment of the present invention;

FIG. 3 shows a schematic view of a monitoring device according to another embodiment of the present invention; and

FIGS. 4A to 4C show schematic views of a monitoring device according to a further embodiment of the present invention.

### DESCRIPTION OF EMBODIMENTS

A fire-extinguisher monitoring system according to an embodiment of the present invention is provided in a mount to which a fire extinguisher is removably mounted. The mount is a bracket that is attached to a wall of a building. The building may contain a plurality of mounts to which respective fire extinguishers are mounted. In a preferred example, the mount may be installed in each room or passageway/hallway in the building. The fire extinguisher is securably mounted to the respective mount. In the event of a fire, a user can remove the fire extinguisher from the mount and activate the fire extinguisher to dispense a fire-suppression fluid (or agent) to extinguish or suppress the fire. In some examples, the fire extinguisher may be in an enclosure or in a cabinet.

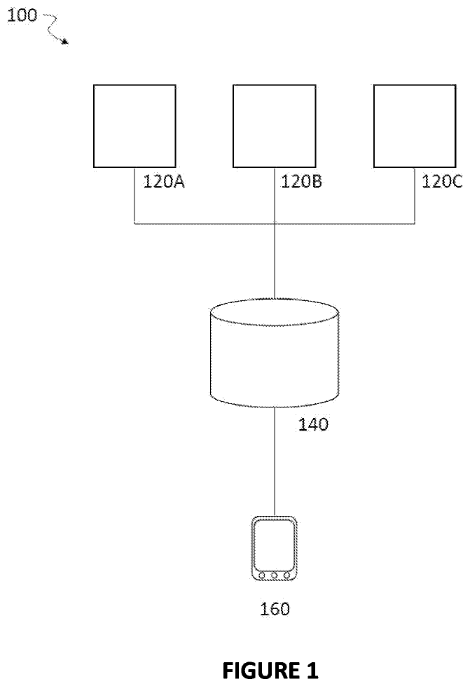

With reference to FIG. 1, a preferred embodiment of the present invention includes a fire-extinguisher monitoring network 100 that includes a plurality of monitoring systems 120A, 120B, 120C for the respective fire extinguishers, each monitoring system being provided in a respective mount to which a fire extinguisher can be removably mounted. The mounts for the respective monitoring systems 120A, 120B, 120C are located at respective locations in a building. Each monitoring system 120A, 120B, 120C includes input sensor(s) for non-intrusive monitoring of the mounted fire extinguisher, an obstruction sensor, a communications module, a processor, local computer memory, and output device(s). The monitoring network 100 includes a central server 140 with which the plurality of monitoring systems 120A, 120B, 120C is in communication. The processor of each monitoring system 120A, 120B, 120C is in communication with the central server 140 via the respective communication module. The central server 140 may communicate with the monitoring systems 120A, 120B, 120C over a wireless communication channel or via a wired connection. The central server 140 includes a computer database that stores information relating to the fire extinguishers. A user's personal electronic device 160 (e.g. a smartphone, computer, a laptop, or tablet) is configured to be in communication with the central server, such that the central server 140 is configured to transmit a notification to the personal electronic device in response to a status or condition of the fire extinguisher(s). The communication between the personal electronic device 160 and the central server may be wired or wireless. The notification may be a message displayed on an electronic display screen of the user device 160 and/or an audio output generated on the user device 160. In addition, when the user desires to determine the status or condition of the fire extinguisher(s), the user can, via their personal electronic device 160, access the information on the database of the central server 140 and/or cause the central server 140 to query the status/condition and obtain updated status/condition information from the plurality of monitoring systems 120A, 120B, 120C.

The mount includes a monitoring device for non-intrusive monitoring one or more statuses or conditions of the fire extinguisher that is located on the mount. The monitoring is ‘non-intrusive’ in that there is no physical connection from the monitoring device to the fire extinguisher. Thereby, apart from mounting the fire extinguisher on the mount, the user does not need to physically connect the fire extinguisher to the monitoring system. In addition, in the event of an emergency, a user can readily remove the fire extinguisher from the mount without having to unplug the fire extinguisher from the monitoring device. The statuses or conditions of the fire extinguisher that are monitored includes a presence of the fire extinguisher and level of fire-suppression fluid contained in the fire extinguisher. In particular, the monitoring system is configured to determine when the fire extinguisher has been removed from the mount. The monitoring system is also configured to determine when the fire extinguisher has been used and/or if fire extinguisher is empty.

The mount includes an arm (or hook) portion on which the fire extinguisher can be hung and, optionally, a foot portion (or base portion) on which the fire extinguisher can be located. In particular, when the fire extinguisher is mounted to the mount, a handle of the fire extinguisher hangs off the arm portion. Where the foot portion is provided in the mount, the fire extinguisher rests on the foot portion. The mount additionally includes a body portion that is attachable to a building wall, the fire extinguisher being next to the body portion. The body portion is an elongate member, while the arm portion and the optional foot portion extends transversely from the body portion.

In one example, the monitoring device includes a load cell or a strain gauge for presence detection and/or weight detection of the fire extinguisher. The load cell or strain gauge is located in the arm portion or body portion of the mount. In another example, the load cell or strain gauge is located in the foot portion of the mount.

In another example, the monitoring device includes a reed switch for sensing a magnet portion of the fire extinguisher for presence detection of the fire extinguisher. In particular, the reed switch is provided in the mount and is configured to trigger upon a metallic surface of the housing of the fire extinguisher coming into close proximity of the reed switch (i.e. when the fire extinguisher is mounted on the mount). Alternatively, a magnet may be attached to the fire extinguisher for triggering the reed switch.

In a further example, the monitoring device includes an ultrasonic sensor for level detection of fire-suppression fluid contained by the fire extinguisher. In particular, the ultrasonic sensor is configured to transmit a signal into the fire extinguisher and to detect a return signal that would be generated when the transmitted signal bounces off a surface of the fire-suppression fluid in the fire extinguisher. The level of the fire-suppression fluid can be determined based on a time delay between the transmitted signal and the return signal. Alternatively, if there is no return signal detected by the ultrasonic sensor, the fire extinguisher is determined to be empty.

In another example, the monitoring device includes an electronic reader system for reading a tag or barcode of the fire extinguisher for presence detection of the fire extinguisher. In this example, the fire extinguisher may have an identifier such as a tag, barcode, or a QR code on a housing surface of the fire extinguisher that faces the wall of the building when mounted on the mount. the identifier may be provided near the handle portion of the fire extinguisher that hangs on the mount.

In yet a further example, the monitoring device includes a combination of two or more of the devices described above.

In addition, the mount includes an obstruction sensor for detecting if there is an obstruction in front of the fire extinguisher that obstructs access to the fire extinguisher. The obstruction sensor may be an optical sensor for example. In particular, the optical sensor may be an ultraviolet (UV) sensor for detecting natural light. In response to the UV sensor detecting no natural light at a front of the mounted fire extinguisher, the processor is configured to determine that the fire extinguisher is obstructed. Alternatively, the optical sensor may include an infrared sensor that is configured to transmit a signal forward to the mount and detect if the transmitted signal is bounced back, which would be indicative of an obstruction being present at the forward of the mount.

The fire-extinguisher monitoring system includes an output device that is configured to provide an audio output and/or a visual output upon a change of monitored status of the fire-extinguisher. The output device is configured to provide an output upon the fire extinguisher being removed and/or upon detecting a low fire-extinguishing content in the fire extinguisher. The output device includes one or more light emitting diode (LED) devices and/or an electronic or piezoelectric buzzer/sounder. By way of example, the buzzer/sounder may be configured to sound, and continue to sound, when the fire extinguisher is removed from the mount.

The fire-extinguisher monitoring system includes a communications module configured to receive information relating to the status of the fire extinguisher from the monitoring device and transmit the information relating to the status to a server and/or electronic device. The communications module is configured to communicate with the server and/or electronic device over a short-range communications protocol or over a long-range communications protocol. For example, the communications module is capable of Wi-Fi, infrared, or Bluetooth communication. The communications may be implemented using an IEEE 802.11 standard. Alternatively, the communications module is configured for wired communication with the central server. In this regard, there may be an electrical cable network connecting the central server to the plurality of monitoring systems.

The fire-extinguisher monitoring system includes a local computer memory that stores a digital address or unique identifier stored, wherein the digital address is indicative of a location of the monitoring device. The fire-extinguisher monitoring system may further include a global positioning system (GPS) tracker for location determination. In particular, the GPS tracker is configured to provide location information of the mount.

The fire-extinguisher monitoring system further includes a processor for receiving and/or transmitting information from the monitoring device, the obstruction sensor, the communications module, the output device, and the local computer memory. The processor may be a microcontroller for example. The processor is activated for receiving information from the monitoring device and for transmitting information, via the communications module, to the server or electronic device at fixed intervals or irregular intervals. By way of example, the processor receives and/or transmits information from the sensor once a day, once a week, once a month. The processor is configured to transmit the information received from the monitoring device upon determining a change in state of the fire extinguisher.

The processor may be configured to store, either locally or in the central server, a weight of the fire extinguisher when full of the fire-suppression fluid. The processor is configured to compare the weight measurements of the fire extinguisher with the stored weight value to determine if the fire extinguisher has been used or if the fire extinguisher is running low on fire suppression fluid and the fire extinguisher needs to be replaced.

The processor is configured to receive the status/condition information of the fire extinguisher from the monitoring device. The processor communicates with the central server, via the communications module, such that the information of the fire extinguishers in the database of the central server can be updated. In response to determining that the fire extinguisher has been removed from the mount or determining that a content of fire-suppression fluid in the fire extinguisher is low or empty, the processor operates the output device. In addition, the processor is in communication with the obstruction sensor and is configured to determine when an obstruction is detected by the obstruction sensor. In response to determining a presence of an obstruction, the processor updates the information in the central server and/or operates the output device.

Preferred embodiments of the monitoring device of the present invention use two or more sensors to monitor different states of a fire extinguisher. In one embodiment, the monitoring device of the present invention has a load cell and a limit switch for sensing the states of the fire extinguisher. The load cell is used to determine a volume or weight of the fire extinguishing material contained in the fire extinguisher by measuring the weight of the fire extinguisher. The load cell can be calibrated accordingly for different fire extinguishers and different volumes of fire extinguishing material contained therein. The limit switch is used to determine the presence or absence of the fire extinguisher. Another embodiment of the monitoring device of the present invention has a plurality of limit switches that are calibrated and arranged at different heights to determine the volume or weight of fire extinguishing material contained in the fire extinguisher. In this embodiment, the plurality of limit switches may for example include a first limit switch that is activatable when the weight of the fire extinguisher drops below 100% of its normal weight when the fire extinguisher is full and a second limit switch that is activatable when the weight of the fire extinguisher falls below a first threshold weight. For example, the first threshold weight may be 80% of the normal weight. In other embodiments, the plurality of limit switches may include additional limit switches that are respectively activatable based on different threshold weights of the fire extinguisher. In yet another embodiment, the present invention uses an ultrasonic sensor for detecting the volume or weight of the fire extinguishing material and a reed switch for detecting the presence and/or absence of a fire extinguisher.

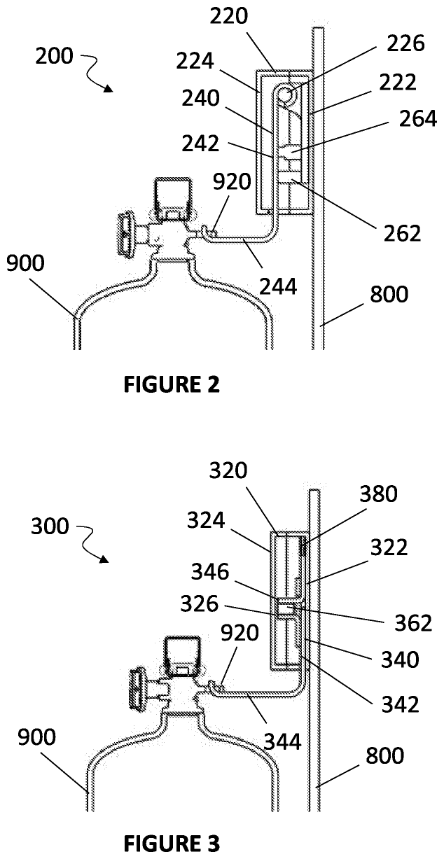

With reference to FIG. 2, a monitoring device 200 according to an embodiment of the present invention is provided in a housing 220. The housing 220 is provided on a wall 800. In other examples, the housing is provided in an enclosure or cabinet in which the fire extinguisher is housed. The housing 220 is a two-part housing having a first housing part 222 that is mounted or attached to the wall 800 and a second housing part 224 that is removably coupled to the first housing part 222 to form the housing 220. The second housing part 224 has an aperture for the passage of a first portion 242 of an arm 240 (or mounting bracket) to which a fire extinguisher 900 is mountable. The aperture is a slot having a width that is larger than a thickness of the arm 240 to allow a forward and/or rearward motion of the arm 240 relative to the first housing part 222. In this regard, the arm 240 is an L-shaped arm having a first portion 242 pivotably coupled to the first housing part 222 and a free portion (or hook portion) 244 to which the fire extinguisher 900 is mounted. The first portion 242 is substantially perpendicular to the free portion 244. The fire extinguisher 900 has a ring portion 920 that is mountable onto the free portion 244 of the arm 240. The housing 200 houses a load cell 262 and a limit switch 264. The load cell 262 and the limit switch 264 are located in the first housing part 222 on a plane that is parallel with the wall 800. The arm 240 is pivotably mounted to the first housing part 222 about pivot 226 and is contactable with the load cell 262 and limit switch 264. When the fire extinguisher 900 is mounted on the free portion 244 of the arm 240, the arm 240 pivots towards the wall 800 due to the weight of the fire extinguisher 900 which causes the first portion 242 of the arm 240 to contact the load cell 262 and limit switch 264. In this state, an amount of fire extinguishing material contained by the fire extinguisher 900 can be determined based on the measurements by the load cell 262 based on the amount of force applied by the arm 240 on the load cell 262 and, when the limit switch 264 is pressed by the arm 240, the presence the fire extinguisher 900 on the arm 240 can be confirmed. When the fire extinguisher 900 is removed from the arm 240, the arm 240 pivots outwardly away from the wall such that the limit switch 264 is no longer pressed. Thereby, the absence of the fire extinguisher 900 on the arm 240 can be confirmed. The arm 240 may be biased outwardly away from the wall such that when the fire extinguisher 900 is removed from the arm 240, the arm 240 moves away from the wall 800 such that the first portion 242 of the arm 240 no longer contacts the limit switch 264. For example, the biasing of the arm 240 may be provided by the limit switch 264. Alternatively, the housing may contain a spring or other biasing means for biasing the arm away from the limit switch when the fire extinguisher is removed from the arm. The second housing part 224 of the housing 220 is removable from the first housing part 222 to allow for any parts in the housing 220 or the arm 240 to be repaired or replaced.

With reference to FIG. 3, a monitoring device 300 according to another embodiment of the present invention is provided in a housing 320. Similar to the previous embodiment, the housing 320 is provided on a wall 800. In other examples, the housing is provided in an enclosure or cabinet in which the fire extinguisher is housed. The housing 320 is a two-part housing having a first housing part 322 that is mounted or attached to the wall 800 and a second housing part 324 that is removably coupled to the first housing part 322 to form the housing 320. The first housing part 322 has an aperture for the passage of a first portion 342 of an arm 340 (or mounting bracket) to which a fire extinguisher 900 is mountable. In this regard, the arm 340 is an L-shaped arm having a first portion 342 and a free portion 344 to which the fire extinguisher 900 is mounted. The first portion 342 is substantially perpendicular to the free portion 344. The fire extinguisher 900 has a ring portion 920 that is mountable onto the free portion of the arm 340. The housing 320 houses a load cell 362 and a limit switch (not shown) are provided. The load cell 362 and the limit switch are located on a platform portion 326 on a plane that is substantially perpendicular or transverse to the wall 800. The platform portion 326 extends outwardly from the first housing part 322 away from the wall 800. The arm 340 is slidably mounted to the first housing portion 342 and is contactable with the load cell 362 and limit switch on the platform portion 326. The arm 340 has a tongue portion 346 for contacting the load cell 362 and the limit switch on the free portion of the platform portion 326. The load cell and limit switch are arranged to be sandwiched between the tongue portion 346 and the platform portion 326. In other examples, the load cell and the limit switch are provided on an underside of the tongue portion and contact the platform portion extending from the first part of the housing when the fire extinguisher is mounted on the arm. When the fire extinguisher 900 is mounted on the arm 340, the arm 340 slides downwardly relative to the wall 800 due to the weight of the fire extinguisher 900 which causes the arm 340 to contact the load cell 362 and limit switch. In this state, an amount of fire extinguishing material contained by the fire extinguisher 900 can be determined based on the measurements by the load cell 362 based on the amount of force applied by the arm 340 on the load cell 362 and, when the limit switch is pressed by the tongue portion 346 of the arm 340, the presence the fire extinguisher 900 on the arm 340 can be confirmed. When the fire extinguisher 900 is removed from the arm 340, the arm 340 slides upwardly relative to the wall such that the limit switch is no longer pressed. Thereby, the absence of the fire extinguisher 900 on the arm 340 can be confirmed. The arm 340 is biased to slide upwardly relative to the wall such that when the fire extinguisher 900 is removed from the arm 340, the arm 340 moves upwardly relative to the wall 800 such that arm 340 no longer contacts the limit switch. In this regard, the device includes a tension return spring 380 at an upper end of the arm and coupled to the housing 320 for biasing the arm 340 upwardly relative to the wall 800.

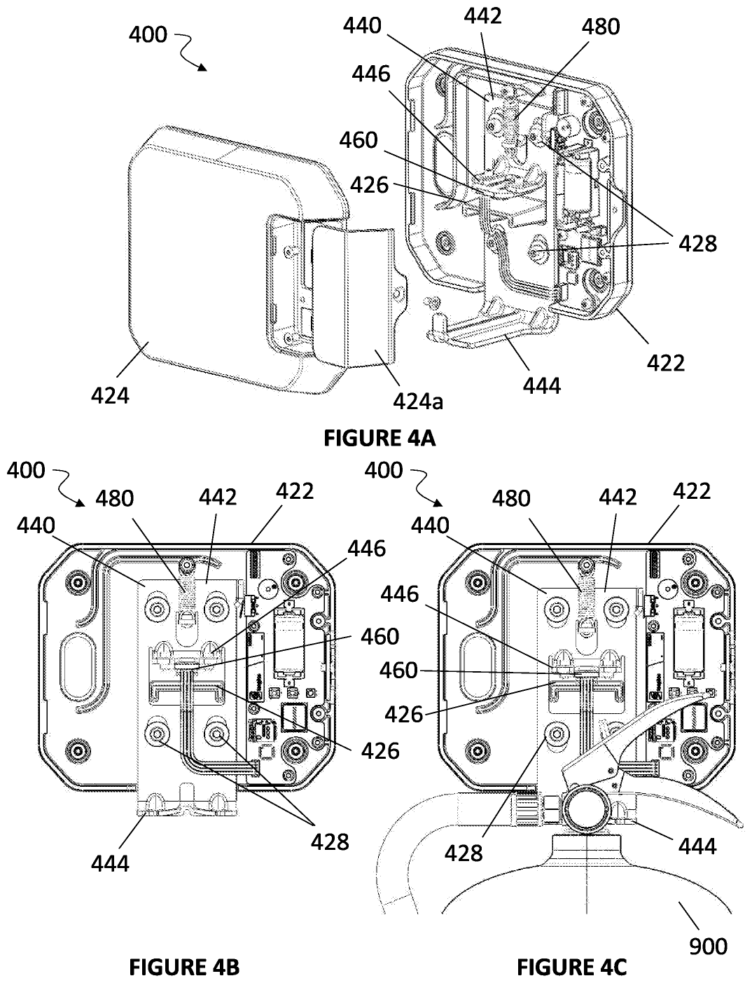

With reference to FIGS. 4A to 4C, a monitoring device 400 according to another embodiment of the present invention is provided in a housing, an exploded view of which is shown in FIG. 4A. Similar to the previous embodiment, the housing is to be provided on a wall. In other examples, the housing is provided in an enclosure or cabinet in which the fire extinguisher is housed. The housing is a two-part housing having a first housing part 422 that is mounted or attached to the wall 800 and a second housing part 424 that is removably coupled to the first housing part 422 to form the housing. The first housing part 422 contains the electronics of the monitoring device, at least one battery for powering the electronics, and actuatable mechanism with which the fire extinguisher interacts. The second housing part 424 covers the electronics, the battery, and a part of the actuatable mechanism contained in the first housing part 422. The second housing part 424 has a removable cover portion 424a that can be removed from the second housing part 424 to reveal the at least one battery contained in the first housing part 422. Thereby, the at least one battery in the housing can be replaced via an access opening in the second housing part 424 that is covered by the cover portion 424a without needing to completely remove the whole second housing part 424 from the first housing part 422.

The first housing part 422 has a platform portion 426 that extends outwardly from a back wall of the first housing part 422, away from the wall 800 to which the first housing part 422 is mounted. The first housing part 422 also has four protrusions 428 that protrude outwardly from the back wall of the first housing part 422. The four protrusions 428 are arranged in a two-by-two arrangement. In other examples, the first housing part may have less than four protrusions or more than four protrusions.

The housing has an aperture for the passage of a first portion 442 of an arm 440 (or mounting bracket) to which a fire extinguisher 900 (shown in FIG. 4C) is mountable. The aperture is defined by a slot in a bottom side wall of the first housing part 422 and the second housing part 424. In this regard, the arm 440 is an L-shaped arm having a first portion 442 and a free portion 444 to which the fire extinguisher 900 is mounted. The first portion 442 is substantially perpendicular to the free portion 444. The fire extinguisher 900 has a ring portion that is mountable onto the free portion of the arm 440. The arm 440 is slidably mounted to the first housing portion 422. In this regard, the first portion 442 of the arm has four guide portions that are respectively engageable with the four protrusions 428 in the first housing part 422. Each guide portion is a slot or channel in the first portion 442 of the arm in which a respective one of the protrusions 428 is locatable. In other examples, the protrusions may be provided on the first portion of the arm and the guide portions may be provided on the first housing part.

The housing houses a sensor arrangement 460 previously described above for monitoring the presence of a fire extinguisher and a volume of fire-extinguishing material contained by the fire extinguisher. The arm 440 has a tongue portion 446 extending outwardly from the first portion 442 of the arm, the sensor arrangement 460 being provided on an underside of the tongue portion 446. The sensor arrangement 460 on the underside of the tongue portion 446 faces the platform portion 426 of the first housing part 422. Thereby, as the arm 440 slides relative to the housing, the tongue portion 446 moves towards or away from the platform portion 426. The sensor arrangement 460 is arranged to be sandwiched between the tongue portion 446 and the platform portion 426. In other examples, the sensor arrangement is provided on the platform portion. When the fire extinguisher 900 is mounted on the arm 440, the arm 440 slides downwardly relative to the housing due to the weight of the fire extinguisher 900 which causes the tongue portion 446 of the arm 440 to move towards the platform portion 426 such that the sensor arrangement 460 contacts the platform portion 426. In this state, an amount of fire extinguishing material contained by the fire extinguisher 900 can be determined based on the measurements by a load cell of the sensor arrangement 460 based on the amount of force applied by the tongue portion 446 of the arm 440 on the load cell against the platform portion 426. Also, in this state, a limit switch of the sensor arrangement 460 on the tongue portion 446 of the arm 440 is pressed against the platform portion 426 such that the presence the fire extinguisher 900 on the arm 440 can be confirmed. When the fire extinguisher 900 is removed from the arm 440, the arm 440 slides upwardly relative to the wall such that the limit switch is no longer pressed. Thereby, the absence of the fire extinguisher 900 on the arm 440 can be confirmed. The arm 440 is biased to slide upwardly relative to the housing such that when the fire extinguisher 900 is removed from the arm 440, the arm 440 moves upwardly relative to the housing such that the tongue portion 446 moves away from the platform portion 426 such that the limit switch is released. In this regard, the device includes a tension return spring 480 at an upper end of the arm 440 that couples the arm 440 to the housing 420 for biasing the arm 440 upwardly relative to the housing.

In another example, the monitoring device has one or more electrical contacts or terminals that are contactable with one or more electrical contacts or terminals of the fire extinguisher. The electrical contact(s) of the monitoring device may be provided on an arm (or hook) portion onto which the fire extinguisher is hung and/or on a foot portion on which the fire extinguisher is mounted. The electrical contact(s) of the fire extinguisher may be integral with the fire extinguisher or attachable to the fire extinguisher. In this example, an electrical circuit is completed when the electrical contact(s) of the monitoring device contact the electrical contact(s) of the fire extinguisher, and is broken when the electrical contact(s) of the monitoring device are not in contact with the electrical contact(s) of the fire extinguisher. In this way, the presence and absence of the fire extinguisher on the monitoring device can be determined based on whether the electrical circuit is complete or broken. When the electrical circuit is broken, the monitoring device is configured to provide an output in the form of a notification on a user's computer or mobile device and/or an audio output and/or a visual output. The electrical contact(s) of the monitoring device may be connected to the electrical network of a building and/or may be electrically connected to a local battery pack. Where the electrical contact(s) of the monitoring device are connected to both the electrical network of the building and to the local battery pack, the battery power pack is a back-up power supply for the monitoring device in the event of any disruptions to the electrical network of the building. The electrical contact, of the monitoring device or the fire extinguisher, is an electrically conductive portion.

The various embodiments of the present invention described above have been presented by way of example only, and not by way of limitation. It will be apparent to a person skilled in the relevant art that various changes in form and detail can be made therein without departing from the spirit and scope of the invention. The present invention should not be limited by any of the exemplary embodiments described above.

1. A fire-extinguisher monitoring system including:
a monitoring device that is externally locatable relative to a fire extinguisher, the monitoring device being arranged or configured to non-intrusively monitor a status of the fire extinguisher, the status including at least one of a presence of the fire extinguisher and level of fire-suppression fluid contained by the fire extinguisher.

2. The fire-extinguisher monitoring system of claim 1, wherein the monitoring device includes at least one of:
a load cell for presence detection and/or weight detection of the fire extinguisher,
a strain gauge for presence detection and/or weight detection of the fire extinguisher.

3. The fire-extinguisher monitoring system of claim 2, wherein the monitoring device includes at least one of:
a reed switch for sensing a magnet portion of the fire extinguisher for presence detection of the fire extinguisher,
an ultrasonic sensor for level detection of fire-suppression fluid contained by the fire extinguisher, and
an electronic reader system for reading a tag or barcode of the fire extinguisher for presence detection of the fire extinguisher.

4. The fire-extinguisher monitoring system of any one of claims 1 to 3, further including an output device that is configured to provide an audio output and/or a visual output upon a change of monitored status of the fire-extinguisher.

5. The fire-extinguisher monitoring system of any one of claims 1 to 4, further including a communications module configured to receive information relating to the status of the fire extinguisher from the monitoring device and transmit the information relating to the status to a server and/or electronic device.

6. The fire-extinguisher monitoring system of any one of claims 1 to 5, further including a processor receiving information from the monitoring device at fixed intervals or irregular intervals.

7. The fire-extinguisher monitoring system of any one of claims 1 to 6, further including a local computer memory that stores a digital address or unique identifier, wherein the digital address or unique identifier is indicative of a location of the monitoring device.

8. A mount to which a fire extinguisher can be mounted, the mount including the fire-extinguisher monitoring system of any one of claims 1 to 7.

9. The mount of claim 8, wherein the mount includes an arm portion on which the fire extinguisher can be hung, the arm portion including the monitoring device.

10. The mount of claim 8 or 9, wherein the mount includes a body portion that is attachable to a building wall, the fire extinguisher being next to the body portion, the body portion including the monitoring device.

1. A fire-extinguisher monitoring device including:
a housing; and
a monitoring device that is externally locatable relative to a fire extinguisher, the monitoring device being arranged or configured to non-intrusively monitor a status of the fire extinguisher such that a user can readily remove the fire extinguisher from a mount without having to unplug the fire extinguisher from the monitoring device, the status including at least one of a presence of the fire extinguisher and level of fire-suppression fluid contained by the fire extinguisher;
wherein the monitoring device includes:
an L-shaped arm slidably mounted to the housing and having a first portion and a second portion substantially perpendicular to the first portion, wherein the fire extinguisher is mounted on the second portion; and
a sensor arrangement disposed within the housing such that, when the fire extinguisher is mounted on the arm, the arm slides downwardly due to the weight of the fire extinguisher, which causes the arm to contact the sensor arrangement to sense the presence.

2. (canceled)

3. (canceled)

4. The fire-extinguisher monitoring device of claim 1, further including an output device that is configured to provide an audio output and/or a visual output upon a change of monitored status of the fire-extinguisher.

5. The fire-extinguisher monitoring device of claim 1, further including a communications module configured to receive information relating to the status of the fire extinguisher from the monitoring device and transmit the information relating to the status to a server and/or electronic device.

6. The fire-extinguisher monitoring device of claim 5, wherein the communications module is configured for sending information from the monitoring device at fixed intervals or irregular intervals.

7. The fire-extinguisher monitoring device of claim 6, further including a local computer memory that stores a digital address or unique identifier, wherein the digital address or unique identifier is indicative of a location of the monitoring device.

8. (canceled)

9. (canceled)

10. (canceled)

11. The fire-extinguisher monitoring device of claim 1, wherein the housing is formed of two parts and wherein a first part of the housing is attached to a wall.

12. The fire-extinguisher monitoring device of claim 11, wherein a second part of the housing has an aperture for the passage of the arm.

13. The fire-extinguisher monitoring device of claim 1, including a ring portion that is mountable to the second portion of the arm and adapted for receiving the fire extinguisher.

14. The fire-extinguisher monitoring device of claim 11, wherein the sensor arrangement is located on a platform portion that is substantially perpendicular or transverse to the wall.

15. The fire-extinguisher monitoring device of claim 14, wherein the arm is slidably mounted to the first housing portion and is contactable with the sensor arrangement on the platform portion.

16. The fire-extinguisher monitoring device of claim 15, wherein the arm has a tongue portion for contacting the sensor arrangement on the platform portion.

17. The fire-extinguisher monitoring device of claim 16, wherein the sensor arrangement is arranged to be sandwiched between the tongue portion and the platform portion.

18. The fire-extinguisher monitoring device of claim 16, wherein the sensor arrangement is provided on an underside of the tongue portion and contact the platform portion extending from the first part of the housing when the fire extinguisher is mounted on the arm.

19. The fire-extinguisher monitoring device of claim 16, wherein the arm is biased to slide upwardly relative to the wall such that when the fire extinguisher is removed from the arm, the arm moves upwardly relative to the wall such that arm no longer contacts the sensor arrangement.

20. The fire-extinguisher monitoring device of claim 19, including a tension return spring at an upper end of the arm and coupled to the housing for biasing the arm upwardly relative to the wall.

21. The fire-extinguisher monitoring device of claim 1, wherein the sensor arrangement includes a load cell and limit switch.

22. The fire-extinguisher monitoring device of claim 5, wherein the communications module communicates wirelessly with the server.

23. The fire-extinguisher monitoring device of claim 5, wherein the communications module communicates with the server over a wired connection.

24. A fire-extinguisher monitoring system including:
a plurality of fire-extinguisher monitoring devices of claim 5; and
a central server in communication with the communications module of each fire- extinguisher monitoring device to monitor a status or condition of each of a plurality of fire extinguishers.

25. The fire-extinguisher monitoring system of claim 24, wherein the server is configured to be in communication with one or more personal electronic devices to transmit notifications to the personal electronic device in response to a status or condition of one or more of the plurality of fire extinguishers.
